(19) United States
(12) Patent Application Publication
(10) Pub. No.: US 2014/0338695 A1
(43) Pub. Date: Nov. 20, 2014

(54) DENTAL FLOSS HOLDER

(71) Applicant: HORNG-CHOU CHANG, New Taipei City (TW)

(72) Inventor: HORNG-CHOU CHANG, New Taipei City (TW)

(21) Appl. No.: 13/898,439

(22) Filed: May 20, 2013

(51) Int. Cl. A61C 15/04; A46B 15/00

(52) U.S. Cl. CPC A61C 15/046; A46B 15/0071
USPC 132/309; 132/323

(57) ABSTRACT

The present invention is to provide a dental floss holder containing a body that includes a fixing portion, which is provided with at least a recess disposed inward so as to constitute a neck for holding the dental floss and is provided with at least a slot for receiving the dental floss in position. Thus a user can operate the dental floss fixed on the body in cooperation with the other end of the dental floss held by fingers (or fixed on another dental floss holder) to easily clean the slits between teeth deep inside the oral cavity.

### (a) TECHNICAL FIELD OF THE INVENTION

The present invention relates to a dental floss holder, particularly having a fixing portion with at least a slot so as to hold the dental floss in position such that a user can easily place the dental floss into mouth and conveniently operate the dental floss to thoroughly clean the slits between teeth.

### (b) DESCRIPTION OF THE PRIOR ART

A conventional toothbrush can be used to clean mouth but cannot easily remove the food residue at the slits between teeth thoroughly. Thus the plaque will easily grow on the surface of teeth. If the plaque has not been cleaned for a substantial period of time, the plaque will create dental calculus and result in the periodontal disease. Therefore many companies have designed various products like dental floss or flosser that are convenient to be carried. However, the length of a flosser is not adequate such that it is not easy to thoroughly clean the food residue at the slits between teeth and most of dentists recommend clean the slits between teeth with dental floss. A commercially available dental floss is in a roll contained inside a box. A user can take the dental floss at a set length for each use. When using the dental floss at a set length, both hands of the user are required to hold both ends of the dental floss in order to clean the slits between teeth with the middle portion of the dental floss. Such cleaning operation has the following disadvantages:
1. The fingers must be inserted into the mouth of the user. Fingers are well known to be contaminated by bacteria or dirt such that the user can easily introduce bacteria or dirt into own mouth while cleaning the slits between teeth resulting in the concern of personal hygiene.
2. It takes skill to operate the dental floss held by the fingers of both hands in order to clean the food residue at the slits between teeth with the repeated back-and-forth movement of the dental floss. Such operation is not convenient for every user. Particularly it is relatively difficult to clean the slits between teeth deep inside mouth.

Therefore the dental floss and its operation of the prior art are in need for improvement.

### SUMMARY OF THE INVENTION

Therefore, an objective of the present invention is to provide a dental floss holder whereby the dental floss fixed on the body of the dental floss holder can be inserted into mouth together with the other end held by fingers of a user (or fixed on the body of another dental floss holder) in order to easily clean the slits between teeth.

In order to achieve the aforesaid objective, the present invention includes a body that contains a fixing portion provided with at least a recess facing inward with respect to the body centerline so as to constitute a neck for holding a dental floss. The body is further provided with at least a slot for receiving the dental floss in position. The dental floss holder of the present invention enables a user to insert the dental floss fixed on the body into mouth and hold the other end of the dental floss by fingers (or fixed on another dental floss holder) for easily cleaning the food residue at the slits between teeth, particularly the teeth deep within oral cavity. Therefore the present invention can not only prevent the contamination of bacteria or dirt into oral cavity but also facilitate the cleaning by dental floss with ease.

### BRIEF DESCRIPTION OF THE DRAWINGS

FIG. 1 is a perspective view of the present invention.

FIG. 2 is a plan view illustrating a preferred embodiment by a left-hand of the present invention.

FIG. 3 is a plan view illustrating a preferred embodiment by a right-hand of the present invention.

FIG. 4 is a schematic view illustrating a preferred embodiment of the present invention in cleaning operation.

FIG. 5 is a plan view illustrating a preferred embodiment of the present invention by both hands.

FIG. 6 is a schematic view illustrating a preferred embodiment of the present invention in a cleaning operation by both hands.

FIG. 7 is a schematic view illustrating an embodiment for dental floss winding according to the present invention to collect food residue.

FIG. 8A is a schematic view illustrating a preferred embodiment of dental floss fixed in position by the fixing portion and slot of the present invention.

FIG. 8B is a schematic view illustrating a preferred embodiment of dental floss fixed in position by the slot of the present invention.

FIG. 9 is a schematic view illustrating a preferred embodiment of the present invention comprising a brush portion.

FIG. 10 is a schematic view illustrating another preferred embodiment of the present invention assembled with a brush portion.

FIG. 11 is a schematic view illustrating the other preferred embodiment of the recess of the fixing portion of the present invention.

FIG. 12 is a schematic view illustrating an embodiment of the present invention comprising a finger ring.

BRIEF DESCRIPTION OF THE DRAWING ELEMENTS

| | | | |
|---|---|---|---|
| 10 | Body | 12 | Body |
| 101 | Slot | 121 | Fixing portion |
| 11 | Brush portion | 1211 | Neck |
| 112 | Set of spring extension | 1212 | Recess |
| 1121 | Extension | 122 | Slot |
| 123 | Slot | 20 | Dental floss |
| 125 | Snap opening | A | Finger |
| 1251 | Press slot | 13 | Finger ring |
| 126 | Slot | B | Thumb |

### DETAILED DESCRIPTION OF THE PREFERRED EMBODIMENTS

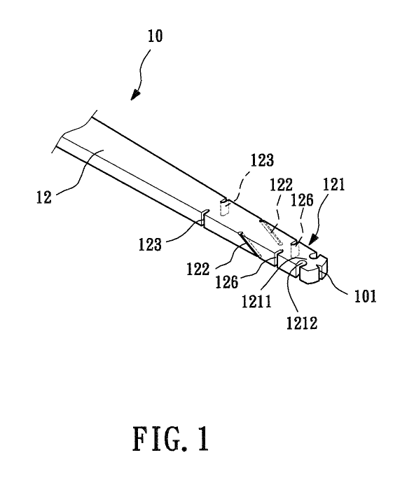

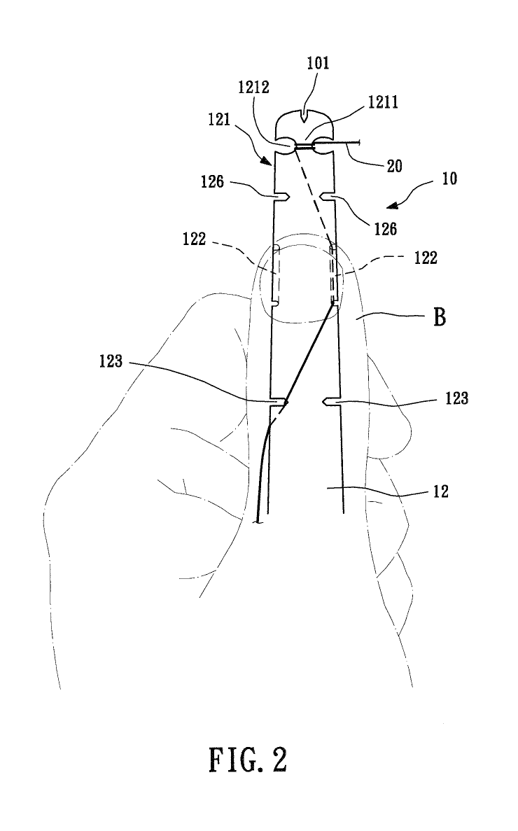

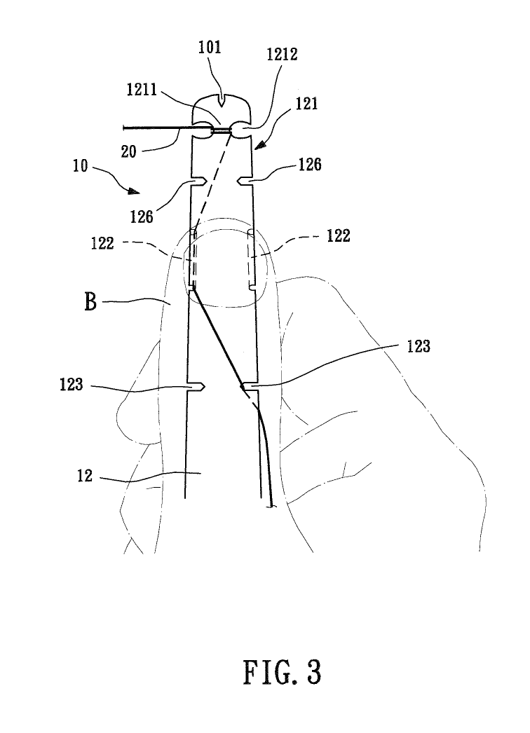

The preferred embodiment of the present invention will be illustrated with reference to FIGS. 1, 2 and 3. A dental floss holder of the present invention, broadly designated at 10, includes a body 12 to be held by a user.

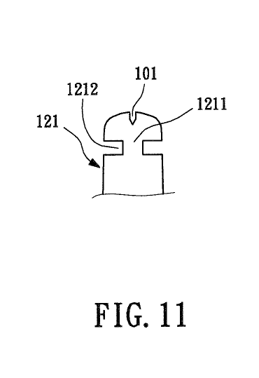

The body 12 is provided with a fixing portion 121 at the front end and the fixing portion 121 has a recess 1212 in either C or rectangle shape (refer FIG. 11) disposed at each of two sides of the body 12 with respect to each other so as to constitute a neck 1211. The body 12 also includes a plurality of slots 122 and slots 123 that the slots 122 are disposed near the fixing portion 121 in an inclined position with respect to the longitudinal axis of the body 12 at its both sides while the slots 123 are disposed far away from the fixing portion 121 in a perpendicular position with respect to the longitudinal axis of the body 12 at its both sides.

The body 12 is further provided with a plurality of slots 126 that are disposed near the fixing portion 121 in a perpendicular position with respect to the longitudinal axis of the body 12 at its both sides.

The body 12 is further provided with a slot 101 that is disposed in a perpendicular position with respect to the longitudinal axis of the body 12 at one of its ends.

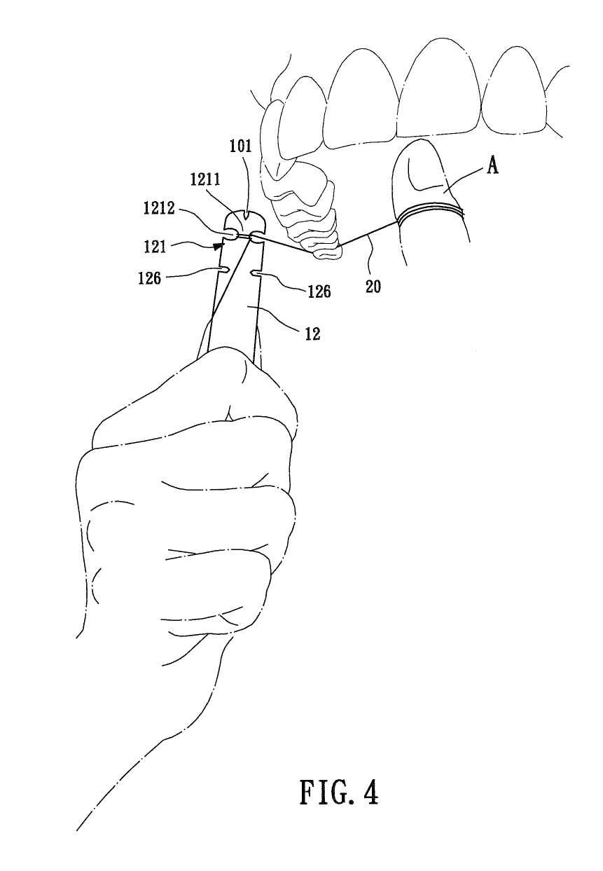

In a cleaning operation, the slots 123 can receive a dental floss 20 in position and then the dental floss 20 is set through the inclined slots 122 to wind around the neck 1211. Thumb B is therefore used to fix the dental floss 20 at location between the slots 122 and slots 123 to prevent the loosening-up of the dental floss 20. With reference to FIG. 4, a user uses a finger A (such as an index or middle finger) to wind one end of the dental floss 20 while its other end is wound around the neck 1211 and then inserts the finger A into mouth for moving the dental floss 20 back-and-forth at the slits between teeth. Thus the food residue will be cleaned while the finger A is in the opening of the mouth so as to prevent the contamination from the finger A into the mouth.

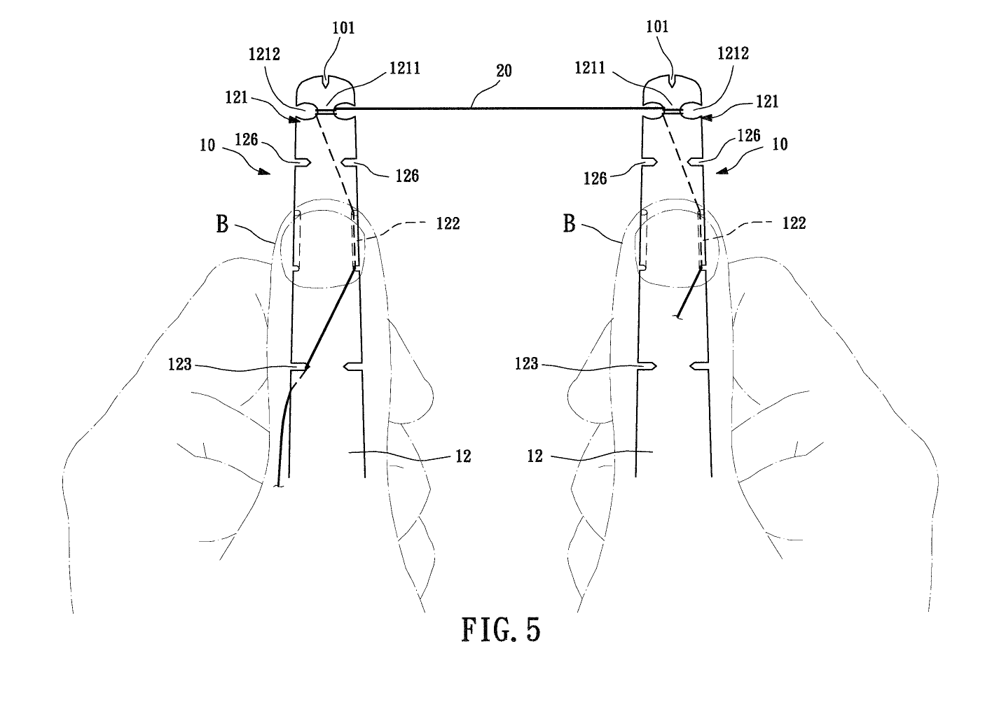

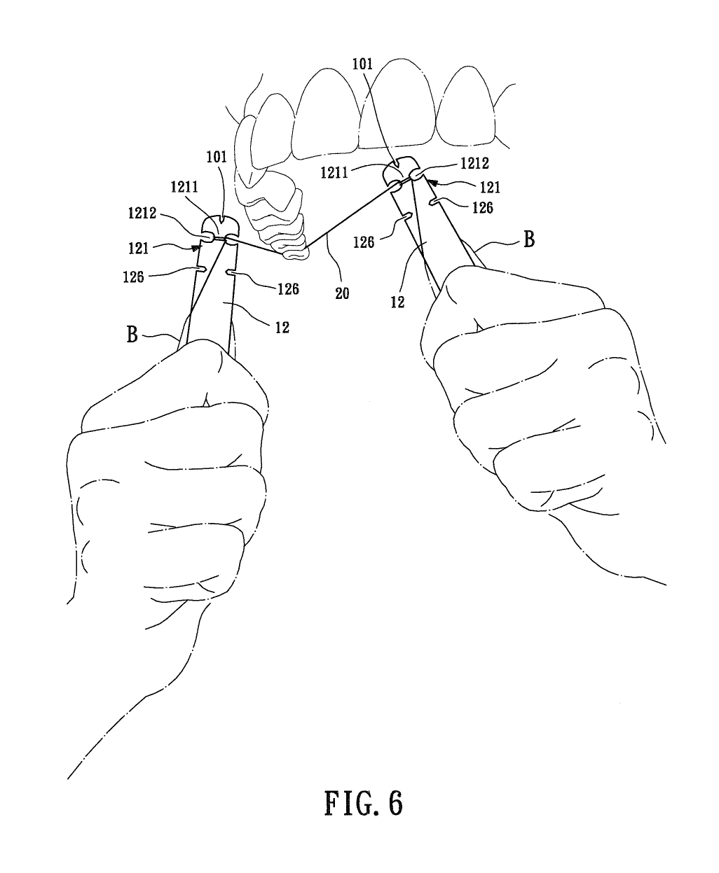

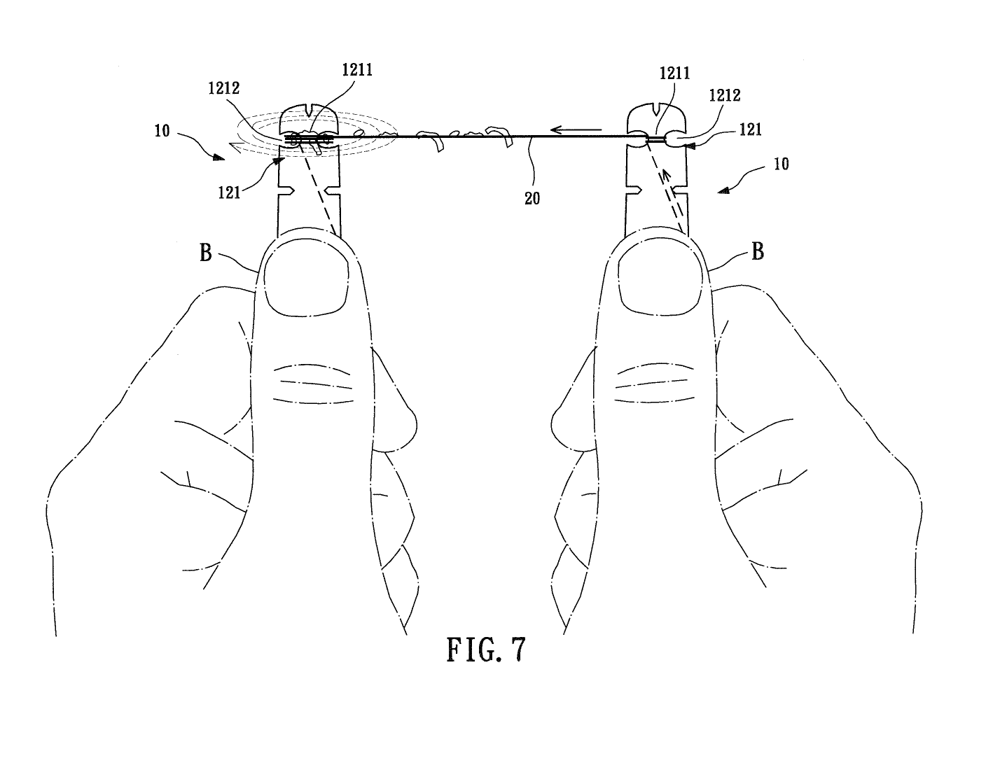

With reference to FIGS. 5 and 6, the dental floss holder 10 of the present invention can be operated by both hands to clean the mouth in the same manner at the same time except to wind the dental floss 20, which is previously fixed by the finger A, on the neck 1211 of another dental floss holder 10 and place a portion of the dental floss 20 into the slot 122 in position by thumb B. With reference to FIG. 7, every section of used dental floss 20 with the food residue being removed can be collected by winding at the recess 1212, in either C or rectangle shape (see FIG. 11), of the neck 1211 disposed at the fixing portion 121 while the unused dental floss 20 can be released by the thumb B from another dental floss holder 10 till the proper length. Therefore the unused dental floss 20 can be continuously put to cleaning the food residue inside the mouth.

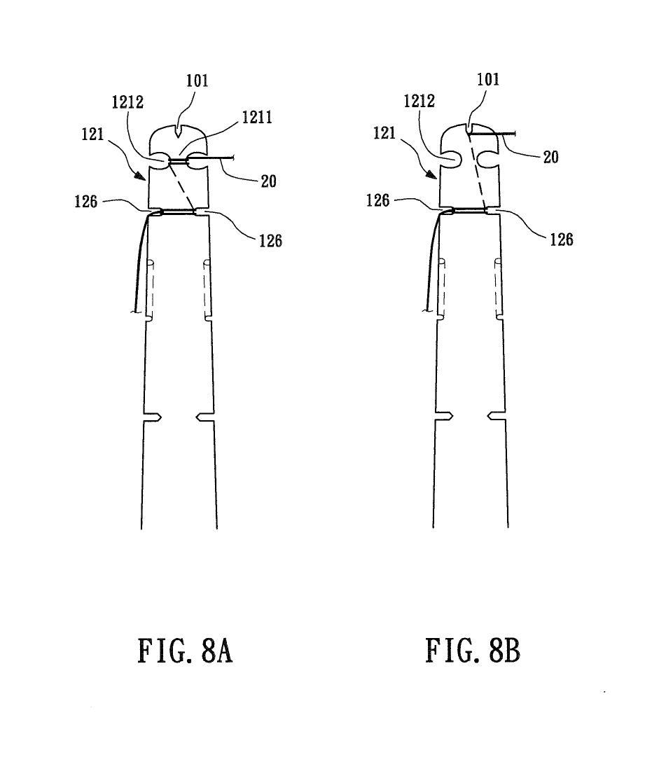

Please refer FIG. 8A, the embodiment of a slot 126. The slot 126 receives the dental floss 20 at least one winding so as to utilize the friction of the dental floss 20 for holding it inside the slot 126 and wrapping around the fixing portion 121. Therefore using the slot 126 alone can fix the dental floss 20 in position without pressing by the thumb B for achieving the other preferred embodiment of the present invention.

Please refer FIG. 8B, which illustrates the embodiment of the slot 126 and 101. The slot 126 receives the dental floss 20 at least one winding so as to utilize the friction of the dental floss 20 for holding it inside the slot 126. Thus using the slot 126 alone can fix the dental floss 20 in position without being pressed by the thumb B. The dental floss 20 is wound in the slot 101 after being wound and fixed in the slot 126 so as to be fixed in position without being pressed by thumb B for achieving another preferred embodiment of the present invention for cleaning food residue. The aforesaid configuration is particularly effective to clean the food residue within the slits between the rearmost molars located deep inside the oral cavity.

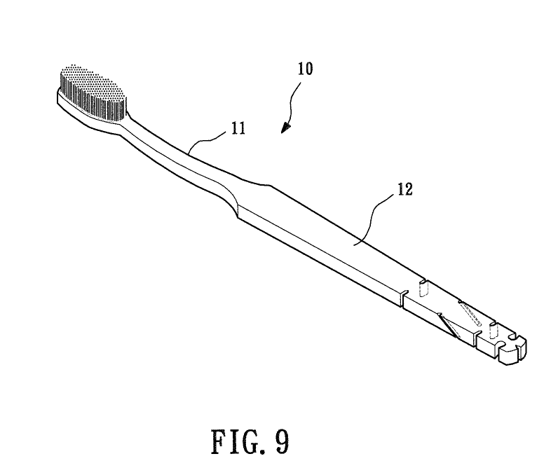

With reference to FIG. 9, the body 12 of the present invention further comprises a brush portion 11 at one end thereof. The body 12 and the brush portion 11 can be integrally formed so that the present invention also has the function of toothbrush.

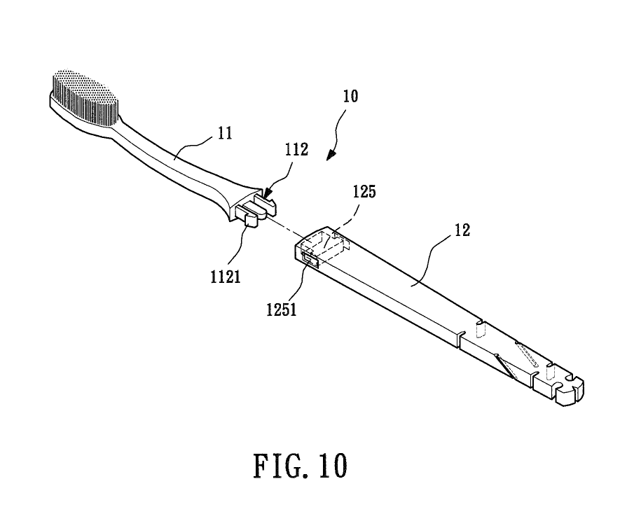

Referring to FIG. 10, an embodiment of assembly structure of the body 12 and the brush portion 11 is shown. One end of the brush portion 11 is provided with a set of spring extension 112 containing two pieces of extension 1121 with predetermined flexibility in hook shape facing outward with respect to each other and one end of the body 12 is provided with a snap opening 125 in a geometry correlated to the set of spring extension 112. The snap opening 125 is provided with at least a press slot 1251 matching two pieces of extension 1121 in geometry so as to utilize the flexibility of two pieces of extension 1121 for assembling the set of spring extension 112 into the snap opening 125 to form a firm device. Further two pieces of extension 1121 is deformed by pressing the press slot 1251 in order to remove the brush portion 11 for exchange.

Further, the body 12 of the present invention can utilize the set of spring extension 112 and the snap opening 125 as an assembly structure to assemble other devices with specific functions, in addition to being assembled with the brush portion 11, for a board range of applications.

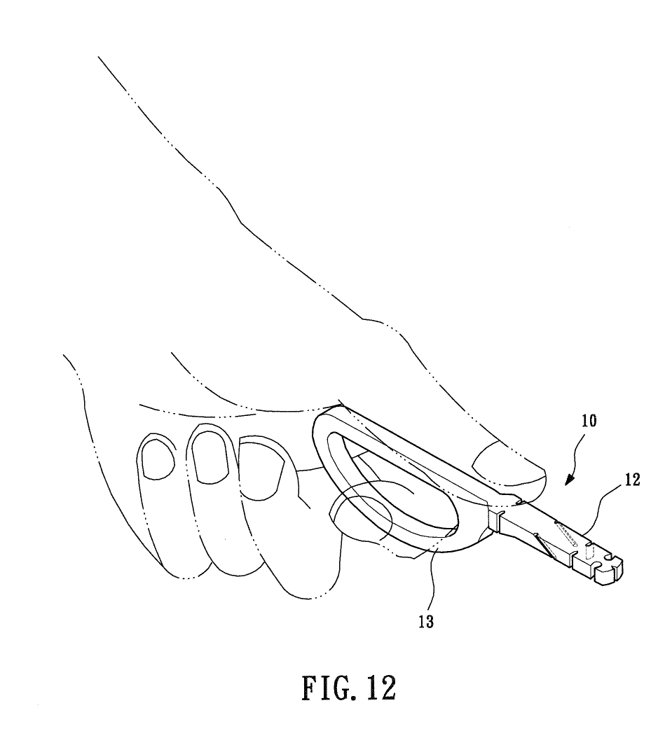

Referring to FIG. 12, the body 12 of the present invention may be further provided with a finger ring 13 for receiving a finger therein. To use, the user bends and inserts a finger (such as an index finger) into the finger ring 13 in a holding status and also places a thumb on and pressing down one side of the body 12. In this way, the user can easily hold and use the present invention.

In summary of the above-mentioned preferred embodiments, the present invention is to provide a dental floss holder by providing a fixing portion at the trail end of the body. The fixing portion can hold one end of the dental floss such that the body can be inserted deep inside the oral cavity for cleaning the food residue at the slits between teeth and ensure the personal hygiene of the user.

It is to be understood that the embodiments of the present invention herein described are merely illustrative for the application of the present invention. Reference herein to details of the illustrated embodiments is not intended to limit the scope of the claims that recite the features regarded as essential to the present invention.

I claim:

1. A dental floss holder comprising:
a body including a fixing portion, provided with at least a recess facing inward with respect to said body centerline so as to constitute a neck for holding a dental floss, and at least a slot, for receiving the dental floss in position.

2. The dental floss holder of claim 1, wherein the slot is disposed at one side of said body in an inclined position with respect to the longitudinal axis of said body.

3. The dental floss holder of claim 1, wherein the slot is disposed at one side of said body in a perpendicular position with respect to the longitudinal axis of said body.

4. The dental floss holder of claim 1, wherein a plurality of the slot is disposed at both sides of said body in a segregated format with respect to each other, one of the plurality of the slot is disposed near the fixing portion in an inclined position while the other of the plurality of the slot is disposed away from the fixing portion in a perpendicular position with respect to the longitudinal axis of said body respectively so as to receive the dental floss within the other of the plurality of the slot in position and wind the dental floss to the fixing portion through the one of the plurality of the slot in which the dental floss is secured in position.

5. The dental floss holder of claim 1, wherein the recess is in C shape so as to constitute the neck.

6. The dental floss holder of claim 1, wherein the recess is in square shape so as to constitute the neck.

7. The dental floss holder of claim 1, wherein said body further comprises a brush portion for cleaning teeth at one end thereof.

8. The dental floss holder of claim 7, wherein the brush portion is provided with a set of spring extension that contains two pieces of extension with flexibility in hook shape facing outward with respect to each other and said body is provided with a snap opening in geometry correlated to the set of spring extension and provided with at least a press slot matching the two pieces of extension in geometry so as to assemble the set of spring extension into the snap opening utilizing the flexibility of the two pieces of extension.

9. The dental floss holder of claim 1, wherein the slot is disposed at one end of said body in a perpendicular position with respect to the longitudinal axis of said body.

10. The dental floss holder of claim 1, wherein the body comprises a finger ring formed at one end thereof for receiving a finger positioned therein.
